(19) United States
(12) Patent Application Publication
(10) Pub. No.: US 2025/0316003 A1
(43) Pub. Date: Oct. 9, 2025

(54) MIXED REALITY FOR LASER SAFETY EYEWEAR

(71) Applicant: Arizona Board of Regents on Behalf of the University of Arizona, Tucson, AZ (US)

(72) Inventors: Hyeonwoo Lee, Tucson, AZ (US); Jalil Shah, Tucson, AZ (US); Mohamed Sennary, Tucson, AZ (US)

(21) Appl. No.: 19/173,042

(22) Filed: Apr. 8, 2025

Related U.S. Application Data
(60) Provisional application No. 63/631,278, filed on Apr. 8, 2024.

(51) Int. Cl. G06T 11/60; G06T 7/70; H04N 23/16; H04N 23/55; H04N 23/57; H04N 23/90

(52) U.S. Cl. CPC G06T 11/60; G06T 7/70; H04N 23/16; H04N 23/55; H04N 23/57; H04N 23/90; G06T 2207/10024; G06T 2207/10048

(57) ABSTRACT

A system for safe mixed-reality visualization of one or more lasers. The system comprises a headset component configured to fit over a user's eyes. The headset component may comprise a plurality of cameras configured to generate images of an environment. The headset component may further comprise a mountable optical device configured to be applied to one or more cameras. Each mountable optical device may comprise a mounting component and one or more inner optical elements operatively coupled to the mounting component. The one or more inner optical elements may comprise an optical filter configured to reduce saturation by the one or more laser beams in the image generated by the camera. The headset component may further comprise a display component communicatively coupled to a computing device, configured to display a combined image to the eyes of the user.

### CROSS-REFERENCE TO RELATED APPLICATION

The present application claims priority to U.S. Provisional Application No. 63/631,278, filed Apr. 8, 2024, which is incorporated herein by reference in its entirety.

### FIELD OF THE INVENTION

The present invention is directed to a versatile mixed-reality system for laser safety and visibility.

### BACKGROUND OF THE INVENTION

Recent high-power lasers experience rapid development in terms of their average power as well as the short pulse with high peak power, for wide applications from satellites to laser weapons. However, conventional safety glasses have been used for multiple decades, and there is no advance in this area. It limits vision and leakage of light, so in reality, around half of the laser researchers do not wear the safety eyewear due to its inconvenience. Recently, the commercial approach to a mixed reality headset has been made by several big-tech companies, which have display panels to see the real world using external cameras.

Present systems exist implementing augmented reality (AR) headsets, waveguide displays integrated into safety glasses, and/or projectors for laser safety. However, these systems require many additional components, require expensive integrated optics, and lack versatility. Thus, there exists a present need for a versatile mixed-reality system for laser safety and visibility.

### BRIEF SUMMARY OF THE INVENTION

It is an objective of the present invention to provide devices and systems that allow for a versatile mixed-reality system for laser safety and visibility, as specified in the independent claims. Embodiments of the invention are given in the dependent claims. Embodiments of the present invention can be freely combined with each other if they are not mutually exclusive.

The present invention features a mountable optical device configured to be applied to one or more optical elements, the device comprising a mounting component and one or more inner optical elements operatively coupled to the mounting component, the one or more inner optical elements comprising an optical filter configured to reduce saturation by one or more laser beams in view of the one or more optical elements.

The present invention features a system for safe mixed-reality visualization of one or more laser beams. The system may comprise a headset component configured to fit over the eyes of a user. The headset component may comprise a plurality of cameras configured to generate images of an environment. The headset component may further comprise a mountable optical device configured to be applied to one or more cameras. Each mountable optical device may comprise a mounting component and one or more inner optical elements operatively coupled to the mounting component.

The one or more inner optical elements may comprise an optical filter configured to reduce saturation by the one or more laser beams in the image generated by the camera. At least one camera of the plurality of cameras may be coupled to at least one of the one or more mountable optical devices. At least one camera of the plurality of cameras may not be coupled to a mountable optical device. The headset component may further comprise a display component communicatively coupled to a computing device, configured to display a combined image to the eyes of the user. The system may further comprise the computing device communicatively coupled to the plurality of cameras and the display component, configured to accept the plurality of images from the plurality of cameras, combine the plurality of images into the combined image, such that the one or more laser beams are safely visible in the combined image, and transmit the combined image to the display component.

One of the unique and inventive technical features of the present invention is the implementation of a mountable optical device for reducing the saturation of laser light. Without wishing to limit the invention to any theory or mechanism, it is believed that the technical feature of the present invention advantageously provides for the safe visualization of laser beams with a device that is configured to be coupled to any pre-existing lens device (e.g. camera, headset, glasses, etc.). None of the presently known prior references or work has the unique inventive technical feature of the present invention.

Additional information can be found in Appendix A of the provisional application Ser. No. 63/631,278 from which the present application claims priority, and the specification of which is included herein in its entirety.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows a schematic diagram of the system for safe mixed-reality visualization of laser beams.

FIG. 2 shows a diagram of the mountable optical device of the present invention, configured to optically manipulate a view of the one or more laser beams.

FIG. 3 shows a diagram of the alert process of the present invention for preventing the user or other objects from contacting laser beams.

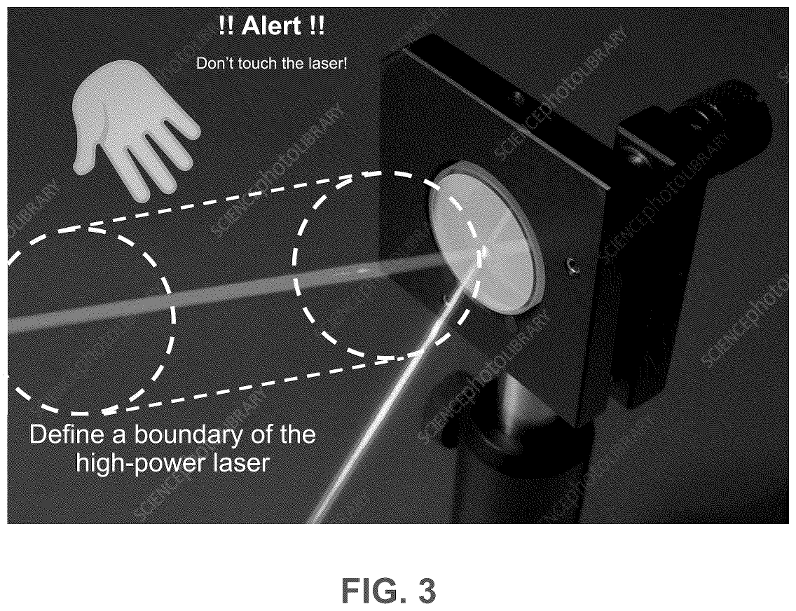

### DETAILED DESCRIPTION OF THE INVENTION

Following is a list of elements corresponding to a particular element referred to herein:
100 system
110 headset component
112 first camera
114 second camera
116 mountable optical device
118 display component
120 computing device
122 processor
124 memory component

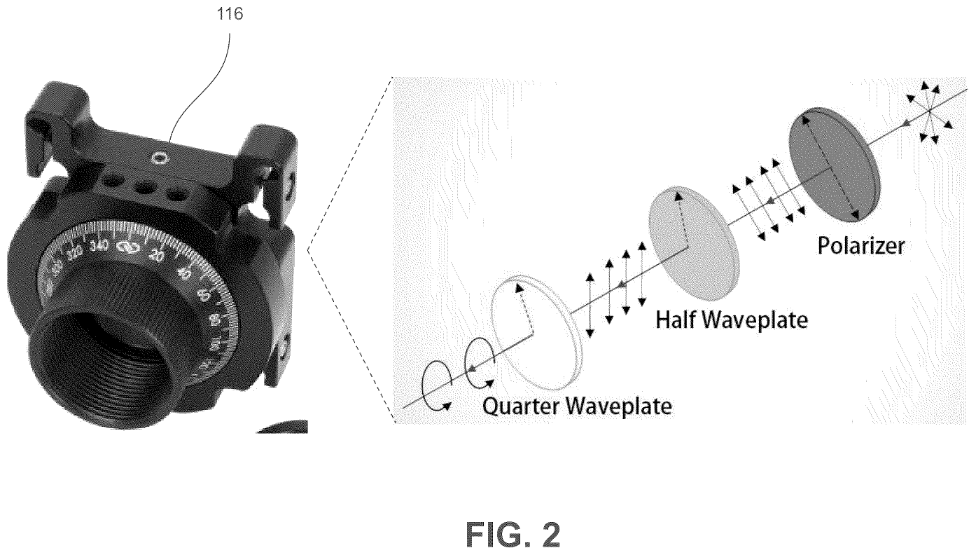

Referring now to FIG. 2, the present invention features a mountable optical device (116) configured to be applied to one or more optical elements, the device comprising a mounting component and one or more inner optical elements operatively coupled to the mounting component, the one or more inner optical elements comprising an optical filter configured to reduce saturation by one or more laser beams in view of the one or more optical elements. In some embodiments, the one or more inner optical elements may further comprise a polarizer, a waveplate, a lens, or a combination thereof. In some embodiments, the mounting component may comprise a clip, an adhesive, and a combination thereof.

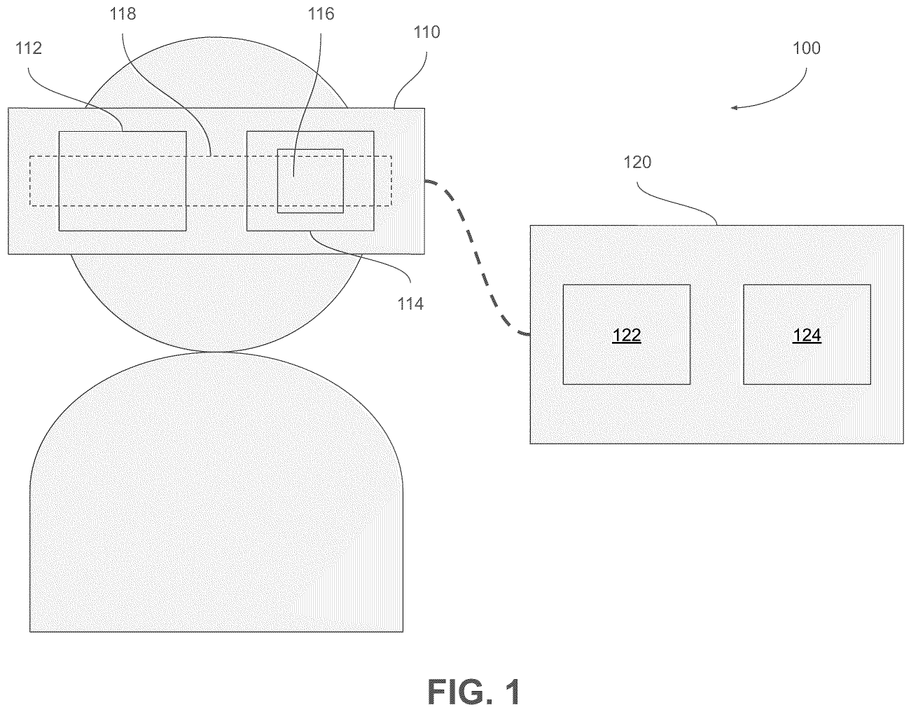

Referring now to FIG. 1, the present invention features a system (100) for safe mixed-reality visualization of one or more laser beams. In some embodiments, the system (100) may comprise a headset component (110) configured to fit over the eyes of a user. The headset component (110) may comprise a plurality of cameras, each camera configured to capture a view of an environment and generate an image based on the view. The headset component (110) may further comprise one or more mountable optical devices configured to be applied to one or more cameras of the plurality of cameras, each mountable optical device (116) comprising a mounting component and one or more inner optical elements operatively coupled to the mounting component, the one or more inner optical elements comprising an optical filter configured to reduce saturation by the one or more laser beams in the image generated by the camera. At least one camera of the plurality of cameras may be coupled to at least one of the one or more mountable optical devices. At least one camera of the plurality of cameras may not be coupled to a mountable optical device (116). The headset component (110) may further comprise a display component (118) communicatively coupled to a computing device (120), configured to display a combined image to the eyes of the user.

The system (100) may further comprise the computing device (120) communicatively coupled to the plurality of cameras and the display component (118), comprising a processor (122) configured to execute computer-readable instructions, and a memory component (124) operatively coupled to the processor (122), comprising computer-readable instructions. The computer-readable instructions may further comprise accepting the plurality of images from the plurality of cameras, combining the plurality of images into the combined image, such that the one or more laser beams are safely visible in the combined image, and transmitting the combined image to the display component (118).

In some embodiments, the one or more inner optical elements may further comprise a polarizer, a waveplate, a lens, or a combination thereof. In some embodiments, the plurality of cameras of the present invention may further comprise one or more shutters, one or more band pass filters, or a combination thereof. In some embodiments, the mounting component may comprise a clip, an adhesive, or a combination thereof. In some embodiments, one or more images of the plurality of images may comprise an ultraviolet image, an infrared image, or a combination thereof. In some embodiments, the computing device (120) may be further communicatively coupled to one or more laser sources configured to generate the one or more laser beams. The memory component (124) may further comprise computer-readable instructions for operating the one or more laser sources. In some embodiments, the memory component (124) may further comprise computer-readable instructions for defining the one or more laser beams in the combined image, defining a threshold distance from each laser beam of the one or more laser beams, detecting one or more objects within the threshold distance of at least one of the one or more laser beams, and transmitting an alert to the display component (118) upon detecting the one or more objects within the threshold distance of the at least one of the one or more laser beams. In some embodiments, the memory component (124) may further comprise computer-readable instructions for shutting down and/or shuttering the one or more laser sources upon detecting the one or more objects within the threshold distance of the at least one of the one or more laser beams. In some embodiments, the plurality of cameras may comprise gray cameras, color cameras, near-infrared cameras, or a combination thereof.

The present invention features a system (100) for safe mixed-reality visualization of one or more laser beams. In some embodiments, the system (100) may comprise a headset component (110) configured to fit over the eyes of a user. The headset component (110) may comprise a first camera (112) configured to capture a first view of an environment and generate a first image based on the first view. The headset component (110) may further comprise a second camera (114) configured to capture a second view of the environment and generate a second image based on the second view. The headset component (110) may further comprise a mountable optical device (116) configured to be applied to the second camera (114), comprising a mounting component and one or more inner optical elements operatively coupled to the mounting component, the one or more inner optical elements comprising an optical filter configured to reduce saturation by the one or more laser beams in the second image. The headset component (110) may further comprise a display component (118) communicatively coupled to a computing device (120), configured to display a combined image and one or more alerts to the eyes of the user.

The system (100) may further comprise the computing device (120) communicatively coupled to the first camera (112), the second camera (114), and the display component (118), comprising a processor (122) configured to execute computer-readable instructions, and a memory component (124) operatively coupled to the processor (122), comprising computer-readable instructions. The computer-readable instructions may comprise accepting the first image from the first camera (112), accepting the second image from the second camera (114), combining the first image and the second image into the combined image, such that the one or more laser beams are safely visible in the combined image, transmitting the combined image to the display component (118), defining the one or more laser beams in the combined image, defining a threshold distance from each laser beam of the one or more laser beams, detecting one or more objects within the threshold distance of at least one of the one or more laser beams, and transmitting an alert to the display component (118) upon detecting the one or more objects within the threshold distance of the at least one of the one or more laser beams.

In some embodiments, the one or more inner optical elements may further comprise a polarizer, a waveplate, a lens, or a combination thereof. In some embodiments, the mounting component may comprise a clip, an adhesive, or a combination thereof. In some embodiments, the first image, the second image, or a combination thereof may comprise an ultraviolet image, an infrared image, or a combination thereof. In some embodiments, the computing device (120) may be further communicatively coupled to one or more laser sources configured to generate the one or more laser beams. The memory component (124) may further comprise computer-readable instructions for operating the one or more laser sources. In some embodiments, the first camera, the second camera, or a combination thereof may comprise gray cameras, color cameras, near-infrared cameras, or a combination thereof. In some embodiments, the headset component (110) may comprise 2 to 10 cameras.

In some embodiments, the cameras, the display component, or a combination thereof may connect to the computing device by a wireless connection. In some embodiments, the wireless connection may comprise Bluetooth™, WiFi, WLAN, or any other form of wireless connection. In some embodiments, the cameras, the display component, or a combination thereof may connect to the computing device by a wired connection. In some embodiments, the computing device may comprise a personal computing device, a portable computing device, a cloud computing device, a server, or any other computing device. In some embodiments, the computing device may be disposed within the headset component, external to the headset component, or a combination thereof. In other embodiments, the present invention may be capable of visualizing a laser spot without the need for any software components.

The computer system can include a desktop computer, a workstation computer, a laptop computer, a netbook computer, a tablet, a handheld computer (including a smartphone), a server, a supercomputer, a wearable computer (including a SmartWatch™), or the like and can include digital electronic circuitry, firmware, hardware, memory, a computer storage medium, a computer program, a processor (including a programmed processor), an imaging apparatus, wired/wireless communication components, or the like. The computing system may include a desktop computer with a screen, a tower, and components to connect the two. The tower can store digital images, numerical data, text data, or any other kind of data in binary form, hexadecimal form, octal form, or any other data format in the memory component. The data/images can also be stored in a server communicatively coupled to the computer system. The images can also be divided into a matrix of pixels, known as a bitmap that indicates a color for each pixel along the horizontal axis and the vertical axis. The pixels can include a digital value of one or more bits, defined by the bit depth. Each pixel may comprise three values, each value corresponding to a major color component (red, green, and blue). A size of each pixel in data can range from 8 bits to 24 bits. The network or a direct connection interconnects the imaging apparatus and the computer system.

The term “processor” encompasses all kinds of apparatus, devices, and machines for processing data, including by way of example a programmable microprocessor, a microcontroller comprising a microprocessor and a memory component, an embedded processor, a digital signal processor, a media processor, a computer, a system on a chip, or multiple ones, or combinations, of the foregoing. The apparatus can include special-purpose logic circuitry, e.g., an FPGA (field programmable gate array) or an ASIC (application-specific integrated circuit). Logic circuitry may comprise multiplexers, registers, arithmetic logic units (ALUs), computer memory, look-up tables, flip-flops (FF), wires, input blocks, output blocks, read-only memory, randomly accessible memory, electronically-erasable programmable read-only memory, flash memory, discrete gate or transistor logic, discrete hardware components, or any combination thereof. The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The processor may include one or more processors of any type, such as central processing units (CPUs), graphics processing units (GPUs), special-purpose signal or image processors, field-programmable gate arrays (FPGAs), tensor processing units (TPUs), and so forth.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, a data processing apparatus.

A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or can be included in, one or more separate physical components or media (e.g., multiple CDs, drives, or other storage devices). The operations described in this specification can be implemented as operations performed by a data processing apparatus on data stored on one or more computer-readable storage devices or received from other sources.

Program code embodied on a computer readable medium may be transmitted using any appropriate medium, including but not limited to wireless, wireline, optical fiber cable, R.F, Bluetooth, storage media, computer buses, etc., or any suitable combination of the foregoing. Computer program code for carrying out operations for aspects of the present disclosure may be written in any combination of one or more programming languages, including an object oriented programming language such as Java, Smalltalk, C#, Ruby, or the like, conventional procedural programming languages, such as Pascal, FORTRAN, BASIC, or similar programming languages, programming languages that have both object-oriented and procedural aspects, such as the “C” programming language, C++, Python, or the like, conventional functional programming languages such as Scheme, Common Lisp, Elixir, or the like, conventional scripting programming languages such as PHP, Perl, Javascript, or the like, or conventional logic programming languages such as PROLOG, ASAP, Datalog, or the like.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks.

However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

Computers typically include known components, such as a processor, an operating system, system memory, memory storage devices, input-output controllers, input-output devices, and display devices. It will also be understood by those of ordinary skill in the relevant art that there are many possible configurations and components of a computer and may also include cache memory, a data backup unit, and many other devices. To provide for interaction with a user, embodiments of the subject matter described in this specification can be implemented on a computer having a display device, e.g., an LCD (liquid crystal display), LED (light emitting diode) display, or OLED (organic light emitting diode) display, for displaying information to the user.

Examples of input devices include a keyboard, cursor control devices (e.g., a mouse or a trackball), a microphone, a scanner, and so forth, wherein the user can provide input to the computer. Other kinds of devices can be used to provide for interaction with a user as well; for example, feedback provided to the user can be in any form of sensory feedback, e.g., visual feedback, auditory feedback, or tactile feedback; and input from the user can be received in any form, including acoustic, speech, or tactile input. Examples of output devices include a display device (e.g., a monitor or projector), speakers, a printer, a network card, and so forth. Display devices may include display devices that provide visual information, this information typically may be logically and/or physically organized as an array of pixels. In addition, a computer can interact with a user by sending documents to and receiving documents from a device that is used by the user; for example, by sending web pages to a web browser on a user's client device in response to requests received from the web browser.

An interface controller may also be included that may comprise any of a variety of known or future software programs for providing input and output interfaces. For example, interfaces may include what are generally referred to as “Graphical User Interfaces” (often referred to as GUI's) that provide one or more graphical representations to a user. Interfaces are typically enabled to accept user inputs using means of selection or input known to those of ordinary skill in the related art. In some implementations, the interface may be a touch screen that can be used to display information and receive input from a user. In the same or alternative embodiments, applications on a computer may employ an interface that includes what are referred to as “command line interfaces” (often referred to as CLI's). CLI's typically provide a text based interaction between an application and a user. Typically, command line interfaces present output and receive input as lines of text through display devices. For example, some implementations may include what are referred to as a “shell” such as Unix Shells known to those of ordinary skill in the related art, or Microsoft® Windows Powershell that employs object-oriented type programming architectures such as the Microsoft®.NET framework.

Those of ordinary skill in the related art will appreciate that interfaces may include one or more GUI's, CLI's, or a combination thereof. A processor may include a commercially available processor such as a Celeron, Core, or Pentium processor made by Intel Corporation®, a SPARC processor made by Sun Microsystems®, an Athlon, Sempron, Phenom, or Opteron processor made by AMD Corporation®, or it may be one of the other processors that are or will become available. Some embodiments of a processor may include what is referred to as a multi-core processor and/or be enabled to employ parallel processing technology in a single or multi-core configuration. For example, a multi-core architecture typically comprises two or more processor “execution cores”. In the present example, each execution core may perform as an independent processor that enables parallel execution of multiple threads. In addition, those of ordinary skill in the related field will appreciate that a processor may be configured in what is generally referred to as 32 or 64 bit architectures, or other architectural configurations now known or that may be developed in the future.

A processor typically executes an operating system, which may be, for example, a Windows type operating system from the Microsoft Corporation®; the Mac OS X operating system from Apple Computer Corp.®; a Unix® or Linux®-type operating system available from many vendors or what is referred to as an open source; another or a future operating system; or some combination thereof. An operating system interfaces with firmware and hardware in a well-known manner and facilitates the processor in coordinating and executing the functions of various computer programs that may be written in a variety of programming languages. An operating system, typically in cooperation with a processor, coordinates and executes functions of the other components of a computer. An operating system also provides scheduling, input-output control, file and data management, memory management, communication control, and related services, all in accordance with known techniques.

Connecting components may be properly termed as computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of the medium. Combinations of media are also included within the scope of computer-readable media.

Although there has been shown and described the preferred embodiment of the present invention, it will be readily apparent to those skilled in the art that modifications may be made thereto that do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A mountable optical device configured to be applied to one or more optical elements, the device comprising a mounting component and one or more inner optical elements operatively coupled to the mounting component, the one or more inner optical elements comprising an optical filter configured to reduce saturation by one or more laser beams in view of the one or more optical elements.

2. The device of claim 1, wherein the one or more inner optical elements further comprise a polarizer, a waveplate, a lens, or a combination thereof.

3. The device of claim 1, wherein the mounting component comprises a clip, an adhesive, and a combination thereof.

4. A system for safe mixed-reality visualization of one or more laser beams, the system comprising:
a. a headset component configured to fit over eyes of a user, the headset component comprising:
i. a plurality of cameras, each camera configured to capture a view of an environment and generate an image based on the view;
ii. one or more mountable optical devices configured to be applied to one or more cameras of the plurality of cameras, each mountable optical device comprising a mounting component and one or more inner optical elements operatively coupled to the mounting component, the one or more inner optical elements comprising an optical filter configured to reduce saturation by the one or more laser beams in the image generated by the camera;
wherein at least one camera of the plurality of cameras is coupled to at least one of the one or more mountable optical devices;
wherein at least one camera of the plurality of cameras is not coupled to a mountable optical device; and
iii. a display component communicatively coupled to a computing device, configured to display a combined image to the eyes of the user; and
b. the computing device communicatively coupled to the plurality of cameras and the display component, comprising a processor configured to execute computer-readable instructions, and a memory component operatively coupled to the processor, comprising computer-readable instructions for:
i. accepting the plurality of images from the plurality of cameras;
ii. combining the plurality of images into the combined image, such that the one or more laser beams are safely visible in the combined image; and
iii. transmitting the combined image to the display component.

5. The system of claim 4, wherein the one or more inner optical elements further comprise a polarizer, a waveplate, a lens, or a combination thereof.

6. The system of claim 4, wherein the mounting component comprises a clip, an adhesive, or a combination thereof.

7. The system of claim 4, wherein one or more images of the plurality of images comprise an ultraviolet image, an infrared image, or a combination thereof.

8. The system of claim 4, wherein the computing device is further communicatively coupled to one or more laser sources configured to generate the one or more laser beams, wherein the memory component further comprises computer-readable instructions for operating the one or more laser sources.

9. The system of claim 4, wherein the memory component further comprises computer-readable instructions for:
a. defining the one or more laser beams in the combined image;
b. defining a threshold distance from each laser beam of the one or more laser beams;
c. detecting one or more objects within the threshold distance of at least one of the one or more laser beams; and
d. transmitting an alert to the display component upon detecting the one or more objects within the threshold distance of the at least one of the one or more laser beams.

10. The system of claim 4, wherein the plurality of cameras comprise gray cameras, color cameras, near-infrared cameras, or a combination thereof.

11. A system for safe mixed-reality visualization of one or more laser beams, the system comprising:
a. a headset component configured to fit over eyes of a user, the headset component comprising:
i. a first camera configured to capture a first view of an environment and generate a first image based on the first view;
ii. a second camera configured to capture a second view of the environment and generate a second image based on the second view;
iii. a mountable optical device configured to be applied to the second camera, comprising a mounting component and one or more inner optical elements operatively coupled to the mounting component, the one or more inner optical elements comprising an optical filter configured to reduce saturation by the one or more laser beams in the second image; and
iv. a display component communicatively coupled to a computing device, configured to display a combined image and one or more alerts to the eyes of the user; and
b. the computing device communicatively coupled to the first camera, the second camera, and the display component, comprising a processor configured to execute computer-readable instructions, and a memory component operatively coupled to the processor, comprising computer-readable instructions for:
i. accepting the first image from the first camera;
ii. accepting the second image from the second camera;
iii. combining the first image and the second image into the combined image, such that the one or more laser beams are safely visible in the combined image;
iv. transmitting the combined image to the display component;
v. defining the one or more laser beams in the combined image;
vi. defining a threshold distance from each laser beam of the one or more laser beams;
vii. detecting one or more objects within the threshold distance of at least one of the one or more laser beams; and
viii. transmitting an alert to the display component upon detecting the one or more objects within the threshold distance of the at least one of the one or more laser beams.

12. The system of claim 11, wherein the one or more inner optical elements further comprise a polarizer, a waveplate, a lens, or a combination thereof.

13. The system of claim 11, wherein the mounting component comprises a clip, an adhesive, or a combination thereof.

14. The system of claim 11, wherein the first image, the second image, or a combination thereof comprise an ultraviolet image, an infrared image, or a combination thereof.

15. The system of claim 11, wherein the computing device is further communicatively coupled to one or more laser sources configured to generate the one or more laser beams, wherein the memory component further comprises computer-readable instructions for operating the one or more laser sources.

16. The system of claim 11, wherein the first camera, the second camera, or a combination thereof comprise gray cameras, color cameras, near-infrared cameras, or a combination thereof.

17. The system of claim 11, wherein the memory component further comprises computer-readable instructions for:
a. shutting down or shuttering the one or more laser sources upon detecting the one or more objects within the threshold distance of the at least one of the one or more laser beams;
b. recording data related to the detection event; and
c. providing a re-activation sequence requiring user authorization before re-enabling the one or more laser sources.

18. The system of claim 11, wherein the computer-readable instructions further comprise instructions for:
a. detecting motion of objects within the environment; and
b. adjusting image processing parameters in real-time based on the detected motion to maintain optimal visualization of the one or more laser beams.

19. The system of claim 4, wherein the optical filter comprises:
a. a wavelength-specific notch filter configured to attenuate light at one or more specific wavelengths corresponding to the one or more laser beams while allowing passage of light at other wavelengths;
b. a variable density filter element having regions of different optical densities; and
c. an adjustable mounting mechanism allowing the variable density filter element to be positioned based on detected laser intensity.

20. The system of claim 11, further comprising a calibration module configured to:
a. detect characteristics of the one or more laser beams, including wavelength, intensity, polarization, and beam profile;
b. adjust filtering parameters of the optical filter based on the detected characteristics;
c. modify image processing parameters used to combine the first image and the second image based on the detected characteristics; and
d. store calibration profiles for different laser types for rapid reconfiguration of the system.
